(19) United States
(12) Patent Application Publication
(10) Pub. No.: US 2004/0236696 A1
(43) Pub. Date: Nov. 25, 2004

(54) History information adding program, fraud determining program using history information, and fraud determining system using history information

(75) Inventors: Osamu Aoki, Tokyo (JP); Mikinori Seita, Tokyo (JP)

Correspondence Address: George A. Loud, P.C., LORUSSO, LOUD & KELLY, 3137 Mount Vernon Avenue, Alexandria, VA, 22305, US

(73) Assignee: INTELLIGENT WAVE, INC.

(21) Appl. No.: 10/747,041

(22) Filed: Dec. 30, 2003

(30) Foreign Application Priority Data
May 23, 2003 (JP) 2003-146128

(51) Int. Cl. G06F 17/60

(52) U.S. Cl. 705/50

(57) ABSTRACT

A fraud determining system adds, to authorization data concerning a present use, history information, such as a difference in time of use or monetary value between the authorization data and authorization data concerning an immediately previous use. When a determination as to whether the present use involves a fraud is made on the basis of the authorization data concerning the present use, it is possible to determine whether or not the present use is irregular from the history information. The result of the determination is reflected in a score, and therefore, the score can be calculated with high reliability.

### BACKGROUND OF THE INVENTION

1. Field of the Invention

The present invention relates to a history information adding program for adding history information to authorization data (data which is sent from a store or the like, and represents the owner of a credit card, the monetary value of a transaction for which settlement is requested, etc.), which is used to determine the probability of occurrence of fraud primarily in use of the credit card; to a fraud determining program using history information added to authorization data; and to a fraud determining system using history information added to authorization data.

2. Description of the Related Art

Customarily, when a credit card is used, in order to prevent fraudulent transactions such as a transaction by a third party who has found the credit card and pretends to be the owner, the store or the like where the card is being used checks with the credit card company to ascertain the credit card balance as well as to conduct a credit inquiry concerning fraudulent use. In a system for such credit inquiry, it is becoming important to perform highly reliable determination using data on past fraudulent use and the like.

At present, credit card companies use a system which automatically determines a score for the possibility of fraudulent use on the basis of authorization data. In such systems, in general, a scoring system utilizing a neural network using neural theory is provided, and authorization data for which a request for fraud determination has been accepted are input to the scoring system in order to determine a score (see Nonpatent Document 1).

A neural network is leading-edge technology which models the structure and information processing function of nerve cells of the human brain. Constructing such a network requires special know-how and a large monetary investment. Accordingly, many credit card companies do not themselves construct a basic system for score determination, but instead typically introduce a general purpose, external system for portions relating to a neural network.

A scoring system using a neural network has problems, in that the logic for making a determination is a black box, so that the basis of determination is unclear to the credit card company or the like which utilizes it. In addition, as the user such as the credit card company does not itself create the neural network, difficulty is encountered in reflecting trends from the authorization data for that company. A conceivable measure for coping with such problems is to construct, in place of a neural network, a scoring system using a Bayesian network which uses Bayesian theory, which has recently come into use in the fields of artificial intelligence and the like. The basis of Bayesian theory is the probability of occurrence, which statistically predicts the probability of occurrence of some event.

In such a scoring system using a Bayesian network, the probability of occurrence of fraud can be determined by extracting factors, such as time, monetary value, and store, from data indicating manners of use of a credit card, classifying the manners of use into cases in accordance with combination of these factors, and calculating, for each case, the probability of occurrence of fraud on the basis of past authorization data. For calculation of the probability of occurrence of fraud, there is created a model in which collected past authorization data are classified on a case-by-case basis. Such a model can improve the reliability of probability of occurrence of fraud by classifying the number of cases and collecting a large number of sets of authorization data for each case. However, if the number of cases excessively increases due to combinations of various factors, the number of samples forming a population decreases, to thereby cause scattering of results and lower the reliability of data. To cope with this problem, the present applicant filed patent applications on the technology for preventing the scattering of data and the lowering of reliability (Unpublished Patent Documents 1-3). Nonpatent Document 1

Asano Yoichiro, Suda Yoshinobu, “Introduction of a Fraudulent Use Detection System and Its Effects”, Gekkan Syohishashinyo, Kinzai Institute for Financial Affairs Research Group, May 2000, pages 16-19.

Unpublished Patent Document 1

Japanese Patent Application No. 2003-129410

Unpublished Patent Document 2

Japanese Patent Application No. 2003-129411

Unpublished Patent Document 3

Japanese Patent Application No. 2003-131377

As described above, by utilizing a scoring system using a neural network or a Bayesian network, a score representing the probability of fraud can be calculated for authorization data for which a request for fraud determination has been received can be calculated in consideration of the result of individual checking as to whether fraudulent use is highly likely to occur. However, irrespective of whether a neural network or a Bayesian network is used, determination is performed only on the basis of the contents of the authorization data for which a request for fraud determination has been received. Namely, even in the case where a credit card is considered to be used in an irregular manner from history information regarding past use of the card, such an irregular use of the card cannot be detected as a fraudulent use because such history information is not contained in the information used for determination of fraudulent use.

Let us now consider a case where, although the contents of a credit card transaction itself corresponding to authorization data for which a request for fraud determination has been received does not contain irregular contents, the credit card can be judged to be used in an irregular manner in consideration of a history of transactions, such as similar transactions carried out consecutively within a short period of time or transactions of expensive articles of the same kind carried out consecutively. In such a case, the probability of fraud can be determined to be high. In a scoring system utilizing a neural network or a Bayesian network, if a result of a judgement on the basis of such a transaction history is added in calculation of a score, a more reliable score can be calculated.

### SUMMARY OF THE INVENTION

An object of the present invention is to cope with the above-described problems and to provide a history information adding program for adding history information to authorization data, which is used to determine the probability of occurrence of fraud primarily in use of a credit card.

Another object of the present invention is to provide a fraud determining program using history information added to authorization data.

Still another object of the present invention is to provide a fraud determining system using history information added to authorization data.

According to a first aspect, the present invention solves the above-described problems by providing a history information adding program for adding history information to authorization data, the program causing a computer to perform: a step of receiving first authorization data concerning a present transaction request from a user; a step of retrieving, from an authorization data history database which stores records of past authorization data, a record of second authorization data concerning a previous transaction request received from the same user immediately before the present transaction request, and obtaining, from the record, data regarding a time of use contained in the second authorization data; a step of calculating a difference in time of use from the data regarding the time of use in the second authorization data and data regarding a time of use contained in the first authorization data; and a step of recording the calculated difference in time of use in a record of the first authorization data, and storing the record into the authorization data history database.

According to a second aspect, the present invention solves the above-described problems by providing a history information adding program for adding history information to authorization data, the program causing a computer to perform: a step of receiving first authorization data concerning a present transaction request from a user; a step of retrieving, from an authorization data history database which stores records of past authorization data, a record of second authorization data concerning a previous transaction request received from the same user immediately before the present transaction request, and obtaining, from the record, data regarding a monetary value contained in the second authorization data; a step of calculating a difference in monetary value from the data regarding the monetary value in the second authorization data and data regarding a monetary value contained in the first authorization data; and a step of recording the calculated difference in monetary value in a record of the first authorization data, and storing the record into the authorization data history database.

The programs according to the first and second aspects of the present invention may cause the computer to perform: a step of retrieving, from the authorization data history database which stores records of past authorization data, a record of second authorization data concerning a previous transaction request received from the same user immediately before the present transaction request, and obtaining, from the record, data regarding an article or service contained in the second authorization data; and a step of recording the data regarding the article or service in a record of the first authorization data, and storing the record into the authorization data history database.

The programs according to the first and second aspects of the present invention may cause the computer to perform: a step of retrieving, from the authorization data history database which stores records of past authorization data, a record of second authorization data concerning a previous transaction request received from the same user immediately before the present transaction request, and obtaining, from the record, data regarding a first date of use contained in the second authorization data; a step of determining, on the basis of the data regarding the first date of use and data regarding a second date of use contained in the first authorization data, whether or not the first date of use and the second date of use are the same; and a step of, if the first date of use and the second date of use are not the same, recording, in a record of the first authorization data, data indicating that the present transaction request is first one in the second date, and storing the record into the authorization data history database.

In these aspects of the present invention, not only authorization data, but also a difference in time or monetary value between the present transaction request and the immediately previous transaction request made by the same user, are recorded in the record provided for each set of authorization data in the database which stores authorization data. In this manner, history information is added to authorization data, and the combined data are stored as a single record. Therefore, when authorization data for which fraud determination is to be performed is obtained, the history information can be obtained for use in fraud determination.

In the case where a difference in time or monetary value between the present transaction request and the immediately previous transaction request is used as history information, it is useful to find irregular transactions, which are highly likely fraudulent; for example, similar transactions made consecutively in a short period of time or transactions of expensive articles made consecutively. Further, if such history information additionally contain data regarding an article or service for which a credit card is used, more irregular transactions, such as consecutive purchases of articles of the same kind or consecutive purchases of extremely expensive articles, can be found easily, whereby the reliability of determination of fraud can be improved. Furthermore, when a present transaction request is first one in a day, it is preferred to reset the difference in time or the difference in monetary value, because of the following reason. For example, when a time difference is counted on the basis of the last transaction of the previous day, the difference naturally increases, so that the result of a determination of continuity may differ from the result of a determination of continuity performed on the basis of a time difference counted within a single day.

According to a third aspect, the present invention solves the above-described problems by providing a history information adding program for adding history information to authorization data, the program causing a computer to perform: a step of receiving first authorization data concerning a present transaction request from a user; a step of specifying, from an authorization data history database which stores records of past authorization data, authorization data sets concerning previous transaction requests received from the same user within a predetermined period of time immediately before the present transaction request, and obtaining the number of the authorization data sets; and a step of recording the number of the authorization data sets in a record of the first authorization data, and storing the record into the authorization data history database.

According to a fourth aspect, the present invention solves the above-described problems by providing a history information adding program for adding history information to authorization data, the program causing a computer to perform: a step of receiving first authorization data concerning a present transaction request from a user; a step of specifying, from an authorization data history database which stores records of past authorization data, authorization data sets concerning previous transaction requests received from the same user within a predetermined period of time immediately before the present transaction request, and obtaining the total of monetary values contained in the authorization data sets; and a step of recording the total of the monetary values in a record of the first authorization data, and storing the record into the authorization data history database.

In these aspects of the present invention, in addition to authorization data, the number of uses or the total of monetary values within a predetermined period of time is recorded, as the recent status of use of a credit card by the same user, in the record provided for each set of authorization data in the database which stores authorization data. In this manner, history information is added to authorization data, and the combined data are stored as a single record. Therefore, when authorization data for which fraud determination is to be performed is obtained, the history information can be obtained for use in fraud determination.

According to a fifth aspect, the present invention solves the above-described problems by providing a history information adding program for adding history information to authorization data, the program causing a computer to perform: a step of receiving first authorization data concerning a present transaction request from a user; a step of specifying, from an authorization data history database which stores records of past authorization data, authorization data sets concerning previous transaction requests received from the same user within a predetermined period of time immediately before the present transaction request, and obtaining at least one article or service recorded in the authorization data sets; and a step of recording data regarding the article or service in a record of the first authorization data, and storing the record into the authorization data history database.

In the present aspect of the present invention, in addition to authorization data, an article purchased at the previous transaction, an article purchased at a transaction preceding the previous transaction, the kind of articles purchased most often within a predetermined period of time, and other items are recorded, as the recent status of shopping of articles or the like by the same user using a credit card, in the record provided for each set of authorization data in the database which stores authorization data. In this manner, history information is added to authorization data, and the combined data are stored as a single record. Therefore, when authorization data for which fraud determination is to be performed is obtained, the history information can be obtained for use in fraud determination.

According to a sixth aspect, the present invention solves the above-described problems by providing a history information adding program for adding history information to authorization data, the program causing a computer to perform: a step of receiving first authorization data concerning a present transaction request from a user; a step of specifying, from an authorization data history database which stores records of past authorization data, authorization data sets concerning previous transaction requests received from the same user within a predetermined period of time immediately before the present transaction request, and obtaining at least one piece of area information recorded in the authorization data sets; and a step of recording data regarding the area information in a record of the first authorization data, and storing the record into the authorization data history database.

In the present aspect of the present invention, in addition to authorization data, the result of comparison between the location of the present use of a card and the present residence of the user or the location of the previous use is recorded, as information regarding the recent area move of the same user, in the record provided for each set of authorization data in the database which stores authorization data. In this manner, area information is added to authorization data, and the combined data are stored as a single record. Therefore, when authorization data for which fraud determination is to be performed is obtained, the history information can be obtained for use in fraud determination.

According to a seventh aspect, the present invention solves the above-described problems by providing a program for determining a fraud by use of history information added to authorization data, the program causing a computer to perform: a step of obtaining, from a record of first authorization data concerning a present transaction request from a user and stored in an authorization data history database which stores records of past authorization data, data regarding a difference in time of use between the first authorization data and second authorization data concerning a previous transaction request received from the same user immediately before the present transaction request; and a step of determining whether the present transaction request involves a fraud, on the basis of the difference in time of use, and with reference to a determination rule database which stores a fraud determination rule.

The program according to the seventh aspect of the present invention may be configured to cause a computer to perform: a step of obtaining, from a record of first authorization data concerning a present transaction request from a user and stored in an authorization data history database which stores records of past authorization data, data regarding a difference in time of use between the first authorization data and second authorization data concerning a previous transaction request received from the same user immediately before the present transaction request, and data regarding a article or service contained in the second authorization data; and a step of determining whether the present transaction request involves a fraud, on the basis of the data regarding the difference in time of use and the article or service, and with reference to a determination rule database which stores a fraud determination rule.

According to an eighth aspect, the present invention solves the above-described problems by providing a program for determining a fraud by use of history information added to authorization data, the program causing a computer to perform: a step of obtaining, from a record of first authorization data concerning a present transaction request from a user and stored in an authorization data history database which stores records of past authorization data, data regarding a difference in monetary value between the first authorization data and second authorization data concerning a previous transaction request received from the same user immediately before the present transaction request; and a step of determining whether the present transaction request involves a fraud, on the basis of the difference in monetary value, and with reference to a determination rule database which stores a fraud determination rule.

The program according to the eighth aspect of the present invention may be configured to cause a computer to perform: a step of obtaining, from a record of first authorization data concerning a present transaction request from a user and stored in an authorization data history database which stores records of past authorization data, data regarding a difference in monetary value between the first authorization data and second authorization data concerning a previous transaction request received from the same user immediately before the present transaction request, and data regarding a article or service contained in the second authorization data; and a step of determining whether the present transaction request involves a fraud, on the basis of the data regarding the difference in monetary value and the article or service, and with reference to a determination rule database which stores a fraud determination rule.

According to a ninth aspect, the present invention solves the above-described problems by providing a program for determining a fraud by use of history information added to authorization data, the program causing a computer to perform: a step of obtaining, from a record of first authorization data concerning a present transaction request from a user and stored in an authorization data history database which stores records of past authorization data, the number of authorization data sets concerning previous transaction requests received from the same user within a predetermined period of time immediately before the present transaction request; and a step of determining whether the present transaction request involves a fraud, on the basis of the number of the authorization data sets and with reference to a determination rule database which stores a fraud determination rule.

According to a tenth aspect, the present invention solves the above-described problems by providing a program for determining a fraud by use of history information added to authorization data, the program causing a computer to perform: a step of obtaining, from a record of first authorization data concerning a present transaction request from a user and stored in an authorization data history database which stores records of past authorization data, the total of monetary values contained in authorization data sets concerning previous transaction requests received from the same user within a predetermined period of time immediately before the present transaction request; and a step of determining whether the present transaction request involves a fraud, on the basis of the total of the monetary values and with reference to a determination rule database which stores a fraud determination rule.

According to an eleventh aspect, the present invention solves the above-described problems by providing a program for determining a fraud by use of history information added to authorization data, the program causing a computer to perform: a step of obtaining, from a record of first authorization data concerning a present transaction request from a user and stored in an authorization data history database which stores records of past authorization data, data regarding at least one article or service selected from authorization data sets concerning previous transaction requests received from the same user within a predetermined period of time immediately before the present transaction request; and a step of determining whether the present transaction request involves a fraud, on the basis of the data regarding the article or service, and with reference to a determination rule database which stores a fraud determination rule.

According to a twelfth aspect, the present invention solves the above-described problems by providing a program for determining a fraud by use of history information added to authorization data, the program causing a computer to perform: a step of obtaining, from a record of first authorization data concerning a present transaction request from a user and stored in an authorization data history database which stores records of past authorization data, data regarding at least one piece of area information selected from authorization data sets concerning previous transaction requests received from the same user within a predetermined period of time immediately before the present transaction request; and a step of determining whether the present transaction request involves a fraud, on the basis of the area information, and with reference to a determination rule database which stores a fraud determination rule.

In the seventh to twelfth aspects of the present invention, history information can be obtained from the authorization data history database including records of authorization data with the history information added thereto, which are created by the first to sixth aspects of the present invention, and the probability of occurrence of fraud can be determined in view of the history of use according to a predetermined rule on the basis of the history information. The history information in these aspects of the present invention has the same significance as in the first to sixth aspects of the present invention.

According to a thirteenth aspect, the present invention solves the above-described problems by providing a providing a program for determining a fraud by use of history information added to authorization data, the program causing a computer to perform: a step of receiving first authorization data concerning a present transaction request from a user; a step of retrieving, from an authorization data history database which stores records of past authorization data, a record of second authorization data concerning a previous transaction request received from the same user immediately before the present transaction request, and obtaining, from the record, data regarding a time of use contained in the second authorization data; a step of calculating a difference in time of use from the data regarding the time of use in the second authorization data and data regarding a time of use contained in the first authorization data; and a step of determining whether the present transaction request involves a fraud, on the basis of the difference in time of use, and with reference to a determination rule database which stores a fraud determination rule.

The program according to the thirteenth aspect of the present invention may be configured to cause the computer to perform: a step of receiving first authorization data concerning a present transaction request from a user; a step of retrieving, from an authorization data history database which stores records of past authorization data, a record of second authorization data concerning a previous transaction request received from the same user immediately before the present transaction request, and obtaining, from the record, data regarding a time of use contained in the second authorization data and data regarding an article or service contained in the second authorization data; a step of calculating a difference in time of use from the data regarding the time of use contained in the second authorization data and data regarding a time of use contained in the first authorization data; and a step of determining whether the present transaction request involves a fraud, on the basis of the difference in time of use and the data regarding article or service, and with reference to a determination rule database which stores a fraud determination rule.

According to a fourteenth aspect, the present invention solves the above-described problems by providing a providing a program for determining a fraud by use of history information added to authorization data, the program causing a computer to perform: a step of receiving first authorization data concerning a present transaction request from a user; a step of retrieving, from an authorization data history database which stores records of past authorization data, a record of second authorization data concerning a previous transaction request received from the same user immediately before the present transaction request, and obtaining, from the record, data regarding a monetary value contained in the second authorization data; a step of calculating a difference in monetary value from the data regarding the monetary value contained in the second authorization data and data regarding a monetary value contained in the first authorization data; and a step of determining whether the present transaction request involves a fraud, on the basis of the difference in monetary value, and with reference to a determination rule database which stores a fraud determination rule.

The program according to the fourteenth aspect of the present invention may be configured to cause the computer to perform: a step of receiving first authorization data concerning a present transaction request from a user; a step of retrieving, from an authorization data history database which stores records of past authorization data, a record of second authorization data concerning a previous transaction request received from the same user immediately before the present transaction request, and obtaining, from the record, data regarding a monetary value contained in the second authorization data and data regarding an article or service contained in the second authorization data; a step of calculating a difference in monetary value from the data regarding the monetary value in the second authorization data and data regarding a monetary value contained in the first authorization data; and a step of determining whether the present transaction request involves a fraud, on the basis of the difference in monetary value and the data regarding article or service, and with reference to a determination rule database which stores a fraud determination rule.

According to a fifteenth aspect, the present invention solves the above-described problems by providing a providing a program for determining a fraud by use of history information added to authorization data, the program causing a computer to perform: a step of receiving first authorization data concerning a present transaction request from a user; a step of specifying, from an authorization data history database which stores records of past authorization data, authorization data sets concerning previous transaction requests received from the same user within a predetermined period of time immediately before the present transaction request, and obtaining the number of the authorization data sets; and a step of determining whether the present transaction request involves a fraud, on the basis of the number of the authorization data sets, and with reference to a determination rule database which stores a fraud determination rule.

According to a sixteenth aspect, the present invention solves the above-described problems by providing a providing a program for determining a fraud by use of history information added to authorization data, the program causing a computer to perform: a step of receiving first authorization data concerning a present transaction request from a user; a step of specifying, from an authorization data history database which stores records of past authorization data, authorization data sets concerning previous transaction requests received from the same user within a predetermined period of time immediately before the present transaction request, and obtaining the total of monetary values contained in the authorization data sets; and a step of determining whether the present transaction request involves a fraud, on the basis of the total of the monetary values, and with reference to a determination rule database which stores a fraud determination rule.

According to a seventeenth aspect, the present invention solves the above-described problems by providing a providing a program for determining a fraud by use of history information added to authorization data, the program causing a computer to perform: a step of receiving first authorization data concerning a present transaction request from a user; a step of specifying, from an authorization data history database which stores records of past authorization data, authorization data sets concerning previous transaction requests received from the same user within a predetermined period of time immediately before the present transaction request, and obtaining at least one article or service recorded in the authorization data sets; and a step of determining whether the present transaction request involves a fraud, on the basis of data regarding the article or service, and with reference to a determination rule database which stores a fraud determination rule.

According to an eighteenth aspect, the present invention solves the above-described problems by providing a providing a program for determining a fraud by use of history information added to authorization data, the program causing a computer to perform: a step of receiving first authorization data concerning a present transaction request from a user; a step of specifying, from an authorization data history database which stores records of past authorization data, authorization data sets concerning previous transaction requests received from the same user within a predetermined period of time immediately before the present transaction request, and obtaining at least one piece of area information recorded in the authorization data sets; and a step of determining whether the present transaction request involves a fraud, on the basis of the area information, and with reference to a determination rule database which stores a fraud determination rule.

In the thirteenth to eighteenth aspects of the present invention, unlike the seventh to twelfth aspects of the present invention in which history information is obtained from an authorization data history database, authorization data concerning the immediately previous transaction are obtained from a database which stores past authorization data. Then the difference in time, monetary value, etc. between the present transaction and the previous transaction is calculated, and the determination as to whether the present transaction involves a fraud is made according to a predetermined rule on the basis of the calculation result. In these aspects of the present invention, the calculated history information is used directly in determination of fraud without being stored in a database. Further, the calculated history information has the same significance as the case of the first to sixth aspects of the present invention.

Moreover, the present invention provides a fraud determining system which utilizes the history information adding program or the fraud determining program according to any one of the first to eighteenth aspects of the present invention.

Namely, according to a nineteenth aspect, the present invention solves the above-described problems by providing a fraud determining system utilizing history information of authorization data, the system comprising: authorization data receiving means for receiving first authorization data concerning a present transaction request from a user; authorization data storing means for storing authorization data concerning past transactions by the user; history information creating means for comparing the first authorization data with second authorization data obtained from the authorization data storing means and concerning an immediately previous transaction request received from the same user, and creating history information; history information adding means for adding the created history information to a record of the first authorization data, and storing the resulting record into the authorization data storing means; fraud determination rule storing means for storing a determination rule for determining a fraud from authorization data; and fraud determining means for obtaining the history information, and determining whether the present transaction request involves a fraud with reference to the fraud determination rule storing means.

According to a twentieth aspect, the present invention solves the above-described problems by providing a fraud determining system utilizing history information of authorization data, the system comprising: authorization data receiving means for receiving first authorization data concerning a present transaction request from a user; authorization data storing means for storing authorization data concerning past transactions by the user; fraud determination rule storing means for storing a determination rule for determining a fraud from authorization data; history information creating means for comparing the first authorization data with second authorization data obtained from the authorization data storing means and concerning a previous transaction request received from the same user immediately before the present transaction request, and creating history information; and fraud determining means for determining whether the present transaction request involves a fraud, on the basis of the history information and with reference to the fraud determination rule storing means.

In the nineteenth and twentieth aspects of the present invention, the history information may include at least one of a difference in time of use, or monetary value, between the first authorization data and the second authorization data. Further, the history information may include data regarding the article or service contained in the second authorization data.

The fraud determining system according to the nineteenth aspect of the present invention includes the history information adding program and the fraud determining program according to the first, second, seventh, and eighth aspects of the present invention. The fraud determining system according to the twentieth aspect of the present invention includes the fraud determining program according to the thirteenth and fourteenth aspects of the present invention.

According to a twenty-first aspect of the present invention, the present invention solves the above-described problems by providing a fraud determining system utilizing the history information of authorization data, the system comprising: authorization data receiving means for receiving first authorization data concerning a present transaction request from a user; authorization data storing means for storing authorization data concerning past transactions by the user; history information creating means for specifying authorization data sets obtained from the authorization data storing means and concerning transaction requests received from the same user within a predetermined period of time immediately before the present transaction request, and creating history information; history information adding means for adding the created history information to a record of the first authorization data, and storing the resulting record into the authorization data storing means; fraud determination rule storing means for storing a determination rule for determining a fraud from authorization data; and fraud determining means for obtaining the history information, and determining whether the present transaction request involves a fraud with reference to the fraud determination rule storing means.

According to a twenty-second aspect of the present invention, the present invention solves the above-described problems by providing a fraud determining system utilizing history information of authorization data, the system comprising: authorization data receiving means for receiving first authorization data concerning a present transaction request from a user; authorization data storing means for storing authorization data concerning past transactions by the user; history information creating means for specifying the first authorization data and authorization data sets obtained from the authorization data storing means and concerning transaction requests received from the same user within a predetermined period of time immediately before the present transaction request, and creating history information; history information adding means for adding the created history information to a record of the first authorization data, and storing the resulting record into the authorization data storing means; fraud determination rule storing means for storing a determination rule for determining a fraud from authorization data; and fraud determining means for obtaining the history information, and determining whether the present transaction request involves a fraud with reference to the fraud determination rule storing means.

In the twenty-first and twenty-second aspects of the present invention, the history information may include at least one of the number of the authorization data sets and the total of monetary values of the authorization data sets. Further, the history information may include at least one of the article/service and the area information recorded in the authorization data sets.

The fraud determining system according to the twenty-first aspect of the present invention includes the history information adding program and the fraud determining program according to the third to sixth and ninth to twelfth aspects of the present invention. The fraud determining system according to the twenty-second aspect of the present invention includes the fraud determining program according to the fifteenth to eighteenth aspects of the present invention.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a block diagram showing the structure of a first embodiment of a fraud determining system utilizing history information according to the present invention;

FIG. 2 is a block diagram showing the structure of a second embodiment of the fraud determining system utilizing history information according to the present invention;

FIG. 3 is a diagram showing the flow of authorization data which is used in the fraud determining system utilizing history information according the present invention;

FIG. 4 is a diagram showing the structure of an authorization data history database of the fraud determining system utilizing history information according to the present invention; and

FIG. 5 is a flow chart showing the processing flow of a history information adding program according to the present invention.

### DESCRIPTION OF THE PREFERRED EMBODIMENTS

Embodiments of the present invention will be described below in detail with reference to the accompanying drawings. The following embodiments are examples illustrative of the present invention, and the present invention is not limited to these embodiments.

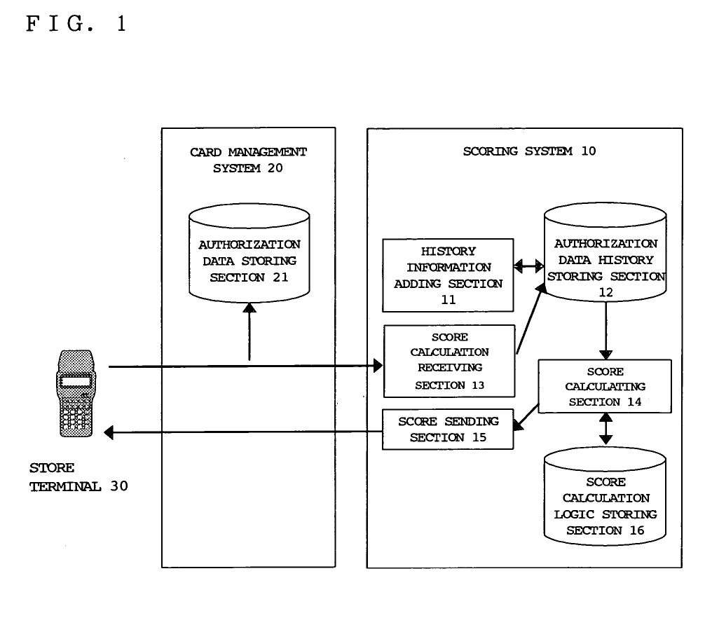

In FIG. 1, a scoring system 10 including the fraud determining system according to the present invention comprises a history information adding section 11, an authorization data history storing section 12, a score calculation receiving section 13, a score calculating section 14, a score sending section 15, and a score calculation logic storing section 16.

Upon being sent from a store terminal 30, authorization data for which a request for fraud determination has been made is received by the score calculation receiving section 13 via a card management system 20. Records for storing the authorization data are provided in the authorization data history storing section 12. In the history information adding section 11, history information is added to the authorization data. The authorization data with history information added is stored into the authorization data history storing section 12 as a single record.

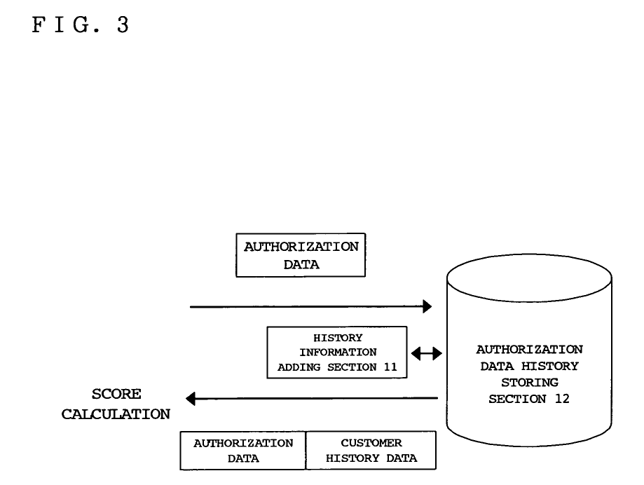

FIG. 3 shows the flow of authorization data to be used in the fraud determining system utilizing history information according to the present invention. The addition of history to the authorization data is performed as follows. In the history information adding section 11, history information is added to the authorization data, which had been received by the score calculation receiving section 13, and the resultant data are stored into the authorization history storing section 12. In the authorization data history storing section 12, authorization data are stored in the form of records, each formed by adding history information to respective sets of authorization data. The authorization data with and history information added thereto are used for calculation of a score.

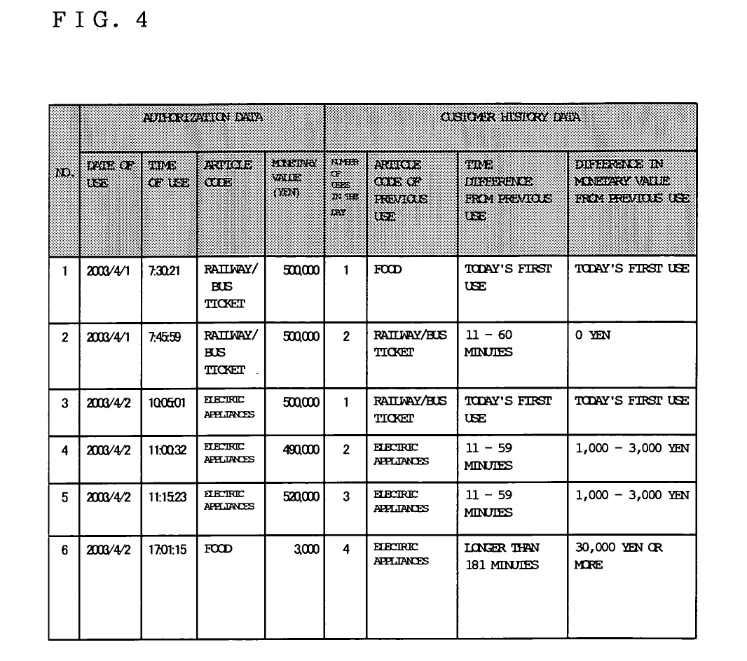

FIG. 4 shows example records of authorization data with history information added thereto. In the authorization data history storing section 12, one table is provided for each credit card user. In each table, a record is provided for each set of authorization data, and has fields for date of use, time of use, article code, and monetary value, which are basic factors contained in the authorization data. In an ordinary authorization data database, only authorization data are stored. However, in the present embodiment, each record has fields for customer history data, such as number of uses within the day, article code of the previous use, difference in time from the previous use, and difference in monetary value from the previous use. By use of these pieces of history information in determining a score, more reliable determination of fraud can be achieved.

Data to be recorded in the fields for customer history data are produced as follows. The history information adding section 11 specifies a record regarding the immediately previous use of the same user, obtains the authorization data of the previous use, and specifies the number of uses within the day and the article code of the previous use. Further, history information adding section 11 calculates the difference in time of use and the difference in monetary value from the authorization data of the present use to be checked, and the authorization data of the previous use, and specifies the difference in time from the previous use and the difference in monetary value from the previous use.

History data created in the history information adding section 11 are not limited to those which are derived from the record of the immediately previous use as in the example of FIG. 4. For example, all records within a predetermined period of time; e.g., within 24 hours, are specified, these records are counted so as to determine the number of times of use of a credit card within the predetermined period of time, and the number of times of use is used as a key for determination of fraud. Alternatively, the sum total of monetary values within a predetermined period of time may be used as such a key. Further, shopping information such as an article purchased last time and the kind of articles purchased most often in past one month, or area information such as the location of the previous purchase may be used as such a key.

Further, because the history data created in the history information adding section 11 are stored as a record in the authorization data history storing section 12, new history data can be created not only from the authorization data themselves but also from past history data, which are stored as additional data of the authorization data. For example, in the case where difference in time from the previous use is added as history data, records of uses within a predetermined period of time are specified while the time of use contained in the authorization data is used as a key, and the number of consecutive uses within a predetermined period of time is calculated with reference to the history data in the records of uses and by use of the difference in time of use as a key, whereby a determination can be made as to whether or not the credit card has been used repeatedly and frequently within a short period of time. Further, in the case where difference in monetary value from the previous use is added as history data, records of uses within a predetermined period of time are specified while the time of use contained in the authorization data is used as a key, and the number of uses within a predetermined range of monetary value is calculated with reference to the history data in these records and by use of the difference in monetary value as a key, whereby a determination can be made as to whether or not use within a predetermined range of monetary value has been repeated frequently within a predetermined period.

In the present embodiment, history data are added to each set of authorization data stored in the authorization data history storing section 12 to form a record, and the thus-formed record is stored into the authorization data history storing section 12. However, there may be used physically separated two databases; i.e., a database for storing authorization data and a database for storing records each including authorization data and history data added thereto. For example, the former may be disposed in the customer management system, and the latter disposed in the scoring system. No limitation is imposed on the functions of systems in which the databases are provided.

The score calculating section 14 retrieves, from the authorization data history storing section 12, a record of authorization data for which a score to be calculated, and obtains, form the record, authorization data and history information added thereto. From the obtained authorization data and history information, a score is calculated in accordance with a logic stored in the score calculation logic storing section 16. The calculated score is sent from the score sending section 15 to the card management system 20.

The score calculation logic storing section 16 stores a logic for calculating a fraud score from authorization data, a logic for calculating a fraud score from history information, and a logic for calculating a final score from these scores calculated respectively from the authorization data and history information. These logics are by no means required to be provided physically in the same storage device, so long as these logics are stored in the scoring system 10.

The logic for calculating a fraud score from authorization data may be a rule base which defines a rule made on the basis of past cases and adapted to find a use which is highly likely fraudulent, scoring by use of a neural network, scoring by use of a Bayesian network, or the like, or any combination thereof.

The logic for calculating a fraud score of a certain use from history information may be designed in such a manner that a determination as to whether the use is judged to be highly likely fraudulent is made on the basis of the difference in time from the immediately previous use, the difference in monetary value from the immediately previous use, etc., and the result of the determination is reflected in the score. By determining the relation between the article or contents of service in the present use and that of the immediately previous use, more reliable determination of fraud can be achieved.

In the example of FIG. 4, authorization data of numbers 2-6 individually are judged not to show a tendency for fraud. Regarding data of number 2, however, from the history information, it can be grasped that articles of the same monetary value were repeatedly purchased within a short period of time; and by referring to the article codes in the authorization data and the history information, it also can be grasped that such articles of consecutive purchases are of the same kind. In this case, the probability of fraud is high, and the highness of the probability of fraud can be reflected in the score. Regarding the difference in monetary value, by referring to the absolute value of the monetary value in the authorization data, it also can be grasped that expensive articles were purchased repeatedly. Regarding data of numbers 4 and 5, like the data of number 2, it can be grasped that the same kind of articles of small difference in monetary value were consecutively purchased within a short period of time. In this case, the probability of fraud is high, and the highness of the probability of fraud can be reflected in the score. By reference to history information, precise determination of fraud can be achieved, which would not be realized by reference to only authorization data.

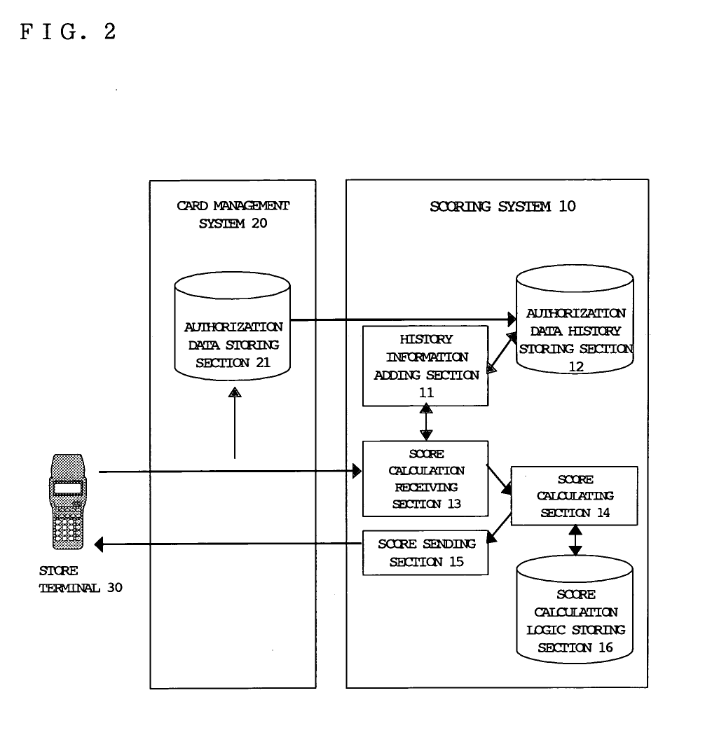

FIG. 2 shows the structure of a second embodiment of the fraud determining system utilizing history information according to the present invention. In the present embodiment, all the sections of the scoring system 10 are completely identical with those in the first embodiment, but the procedure of adding the history information differs from that in the above-described first embodiment. In the present embodiment, when the score calculating section 13 receives authorization data for which a request for fraud determination has been made, the history information adding section 11 obtains, from the authorization data history storing section 12 storing past authorization data, authorization data of the immediately previous use, calculates the difference in time of use or the like from the authorization data received by the score calculating section 13 and the authorization data of the immediately previous use, adds these data items to the received authorization data, and sends such combined data to the score calculating section 14. Alternatively, the history information adding section 11 obtains the number of uses (authorization data), the sum total of monetary values, or the like, within a predetermined period of time, adds these data items to the authorization data, and sends such combined data are sent to the score calculating section 14. Procedures other than those described here are identical with those of the above-described first embodiment.

However, as described above, in order to create, from the added history information, new history information for use in determination of fraud, it is necessary to combine the history information created in the history information adding section 11 with the authorization data to form a record, and store the record in the authorization data history storing section 12.

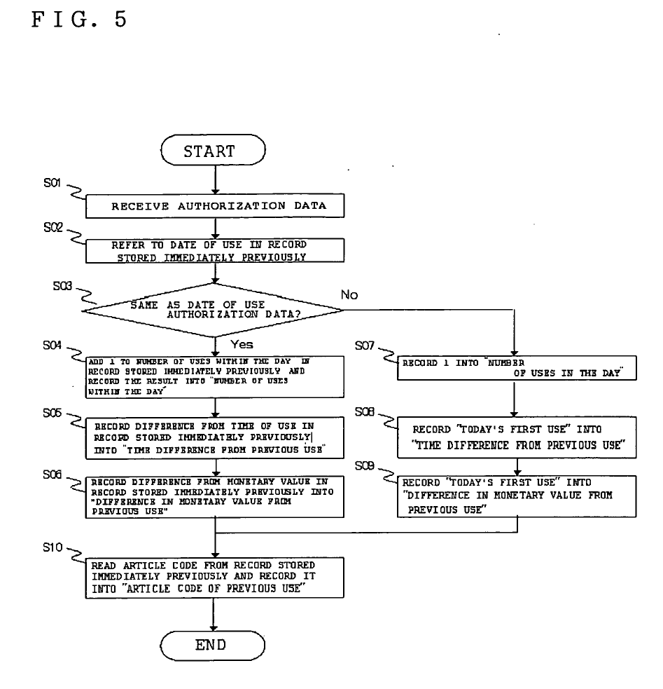

By reference to the flow chart of FIG. 5, the processing flow of the history information adding program according to the present invention will now be described. This flow chart is designed to obtain immediately previous authorization data for addition of history information. The history information adding program according to the present invention may be designed in different manners; for example, the program may be designed to refer to a plurality sets of authorization data of uses within a predetermined period of time.

First, authorization data for which a request for fraud determination has been made is received (S01). Reference is made to the date of use in the record of the immediately previous use in the database storing past authorization data (S02). A determination is made as to whether or not the date of use is identical with the immediately previous use (S03). If the result of determination is YES, a value obtained by adding 1 to the number of uses within the day in the record of the immediately previous use is recorded in the field “number of uses within the day” in the record provided for the received authorization data (S04). Further, the difference between the time of use in the record of the immediately previous use and the time of use in the received authorization data is calculated, and the calculated difference is recorded in the field “difference in time from previous use” (S05). Furthermore, the difference between the monetary value in the record of the immediately previous use and the monetary value in the received authorization data is calculated, and the calculated difference is recorded in the field “difference in monetary value from previous use” (S06).

If the result of determination in step S03 is No, 1 is recorded in the field “number of uses within the day” in the record of the received authorization data (S07). Further, “today's first use” is recorded in the field “time difference from previous use” (S08). Furthermore, “today's first use” is recorded in the field “difference in monetary value from previous use” (S09).

Finally, the article code in the record of the immediately previous use is obtained and recorded in the field “article code of previous use” in the record of the received authorization data (S10), whereby the processing for adding history information to authorization data to form a record is completed.

According to the present invention, not only the results of determination on the basis of information from authorization data themselves for which a request for fraud determination has been received, but also the results of determination on the basis of history information concerning past use are reflected in a score for fraud determination. Therefore, a more reliable score can be calculated.

Obviously, numerous modifications and variations of the present invention are possible in light of the above teachings. It is therefore to be understood that within the scope of the appended claims, the present invention may be practiced otherwise than as specifically described herein.

What is claimed is:

1. A history information adding program for adding history information to authorization data, the program causing a computer to perform:
a step of receiving first authorization data concerning a present transaction request from a user;
a step of retrieving, from an authorization data history database which stores records of past authorization data, a record of second authorization data concerning a previous transaction request received from the user immediately before the present transaction request, and obtaining, from the record, at least one of data regarding a time of use and data regarding a monetary value contained in the second authorization data;
a step of calculating at least one of a difference in time of use and a difference in monetary value, the difference in time of use being calculated from the data regarding the time of use contained in the second authorization data and data regarding a time of use contained in the first authorization data, the difference in monetary value being calculated from the data regarding the monetary value contained in the second authorization data and data regarding a monetary value contained in the first authorization data; and
a step of recording at least one of the difference in time of use and the difference in monetary value in a record of the first authorization data, and storing the record into the authorization data history database.

2. A history information adding program according to claim 1, wherein the program causes the computer to perform:
a step of obtaining data regarding an article or service contained in the record of the second authorization data retrieved from the authorization data history database and concerning the previous transaction request received from the user immediately before the present transaction request; and
a step of recording the data regarding the article or service in a record of the first authorization data, and storing the record into the authorization data history database.

3. A history information adding program for adding history information to authorization data, the program causing a computer to perform:
a step of receiving first authorization data concerning a present transaction request from a user;
a step of specifying, from an authorization data history database which stores records of past authorization data, authorization data sets concerning previous transaction requests received from the user within a predetermined period of time immediately before the present transaction request, and obtaining at least one of the number of the authorization data sets and the total of monetary values contained in the authorization data sets; and
a step of recording said at least one of the number of the authorization data sets and the total of monetary values in a record of the first authorization data, and storing the record into the authorization data history database.

4. A history information adding program for adding history information to authorization data, the program causing a computer to perform:
a step of receiving first authorization data concerning a present transaction request from a user;
a step of specifying, from an authorization data history database which stores records of past authorization data, authorization data sets concerning previous transaction requests received from the user within a predetermined period of time immediately before the present transaction request, and obtaining at least one article or service, or at least one piece of area information contained in the authorization data sets; and
a step of recording data regarding the article or service, or data regarding the area information, in a record of the first authorization data, and storing the record into the authorization data history database.

5. A history information adding program according to claim 1, wherein the program causes the computer to perform:
a step of retrieving, from the authorization data history database which stores records of past authorization data, a record of second authorization data concerning a previous transaction request received from the user immediately before the present transaction request, and obtaining, from the record, data regarding a first date of use contained in the second authorization data;
a step of determining, on the basis of the data regarding the first date of use and data regarding a second date of use contained in the first authorization data, whether or not the first date of use and the second date of use are the same; and
a step of, if the first date of use and the second date of use are not the same, recording, in a record of the first authorization data, data indicating that the present transaction request is first one in the second date, and storing the record into the authorization data history database.

6. A history information adding program according to claim 2, wherein the program causes the computer to perform:
a step of retrieving, from the authorization data history database which stores records of past authorization data, a record of second authorization data concerning a previous transaction request received from the user immediately before the present transaction request, and obtaining, from the record, data regarding a first date of use contained in the second authorization data;
a step of determining, on the basis of the data regarding the first date of use and data regarding a second date of use contained in the first authorization data, whether or not the first date of use and the second date of use are the same; and
a step of, if the first date of use and the second date of use are not the same, recording, in a record of the first authorization data, data indicating that the present transaction request is first one in the second date, and storing the record into the authorization data history database.

7. A history information adding program according to claim 3, wherein the program causes the computer to perform:
a step of retrieving, from the authorization data history database which stores records of past authorization data, a record of second authorization data concerning a previous transaction request received from the user immediately before the present transaction request, and obtaining, from the record, data regarding a first date of use contained in the second authorization data;
a step of determining, on the basis of the data regarding the first date of use and data regarding a second date of use contained in the first authorization data, whether or not the first date of use and the second date of use are the same; and
a step of, if the first date of use and the second date of use are not the same, recording, in a record of the first authorization data, data indicating that the present transaction request is first one in the second date, and storing the record into the authorization data history database.

8. A history information adding program according to claim 4, wherein the program causes the computer to perform:
a step of retrieving, from the authorization data history database which stores records of past authorization data, a record of second authorization data concerning a previous transaction request received from the user immediately before the present transaction request, and obtaining, from the record, data regarding a first date of use contained in the second authorization data;
a step of determining, on the basis of the data regarding the first date of use and data regarding a second date of use contained in the first authorization data, whether or not the first date of use and the second date of use are the same; and
a step of, if the first date of use and the second date of use are not the same, recording, in a record of the first authorization data, data indicating that the present transaction request is first one in the second date, and storing the record into the authorization data history database.

9. A fraud determining program for determining a fraud by use of history information added to authorization data, the program causing a computer to perform:
a step of obtaining, from a record of first authorization data concerning a present transaction request from a user and stored in an authorization data history database which stores records of past authorization data, at least one of data regarding a difference in time of use between the first authorization data and second authorization data concerning a previous transaction request received from the user immediately before the present transaction request, data regarding a difference in monetary value between the first authorization data and the second authorization data, or data regarding an article and service contained in the second authorization data; and
a step of determining whether the present transaction request involves a fraud, on the basis of at least one of the data regarding the difference in time of use, the data regarding the difference in monetary value, and the data regarding the article or service, and with reference to a determination rule database which stores a fraud determination rule.

10. A fraud determining program for determining a fraud by use of history information added to authorization data, the program causing a computer to perform:
a step of obtaining, from a record of first authorization data concerning a present transaction request from a user and stored in an authorization data history database which stores records of past authorization data, at least one of the number of authorization data sets concerning previous transaction requests received from the user within a predetermined period of time immediately before the present transaction request, or the total of monetary values contained in the authorization data sets; and
a step of determining whether the present transaction request involves a fraud, on the basis of at least one of the number of the authorization data sets and the total of monetary values, and with reference to a determination rule database which stores a fraud determination rule.

11. A fraud determining program for determining a fraud by use of history information added to authorization data, the program causing a computer to perform:
a step of obtaining, from a record of first authorization data concerning a present transaction request from a user and stored in an authorization data history database which stores records of past authorization data, data regarding at least one article or service, or at least one piece of area information, selected from authorization data sets concerning previous transaction requests received from the user within a predetermined period of time immediately before the present transaction request; and
a step of determining whether the present transaction request involves a fraud, on the basis of the data regarding the article or service or the data regarding area information, and with reference to a determination rule database which stores a fraud determination rule.

12. A fraud determining program for determining a fraud by use of history information added to authorization data, the program causing a computer to perform:
a step of receiving first authorization data concerning a present transaction request from a user;
a step of retrieving, from an authorization data history database which stores records of past authorization data, a record of second authorization data concerning a previous transaction request received from the user immediately before the present transaction request, and obtaining, from the record, at least one of data regarding a time of use and data regarding a monetary value contained in the second authorization data;
a step of calculating at least one of a difference in time of use and a difference in monetary value, the difference in time of use being calculated from the data regarding the time of use contained in the second authorization data and data regarding a time of use contained in the first authorization data, the difference in monetary value being calculated from the data regarding the monetary value contained in the second authorization data and data regarding a monetary value contained in the first authorization data;
a step of determining whether the present transaction request involves a fraud, on the basis of at least one of the difference in time of use and the difference in monetary value, and with reference to a determination rule database which stores a fraud determination rule.

13. A fraud determining program for determining a fraud by use of history information added to authorization data, the program causing a computer to perform:
a step of receiving first authorization data concerning a present transaction request from a user;
a step of specifying, from an authorization data history database which stores records of past authorization data, authorization data sets concerning previous transaction requests received from the user within a predetermined period of time immediately before the present transaction request, and obtaining at least one of the number of the authorization data sets and the total of monetary values contained in the authorization data sets; and
a step of determining whether the present transaction request involves a fraud, on the basis of at least one of the number of the authorization data sets and the total of monetary values, and with reference to a determination rule database which stores a fraud determination rule.

14. A fraud determining program for determining a fraud by use of history information added to authorization data, the program causing a computer to perform:
a step of receiving first authorization data concerning a present transaction request from a user;
a step of specifying, from an authorization data history database which stores records of past authorization data, authorization data sets concerning previous transaction requests received from the user within a predetermined period of time immediately before the present transaction request, and obtaining at least one of article or service or at least one piece of area information recorded in the authorization data sets; and
a step of determining whether the present transaction request involves a fraud, on the basis of at least one of data regarding the article or service and data regarding the area information, and with reference to a determination rule database which stores a fraud determination rule.

15. A fraud determining system utilizing history information of authorization data, the system comprising:
authorization data receiving means for receiving first authorization data concerning a present transaction request from a user;
authorization data storing means for storing authorization data concerning past transactions by the user;
history information creating means for comparing the first authorization data with second authorization data obtained from the authorization data storing means and concerning a transaction request received from the user immediately before the first transaction request, and creating history information;
history information adding means for adding the created history information to a record of the first authorization data, and storing the record into the authorization data storing means;
fraud determination rule storing means for storing a determination rule for determining a fraud from authorization data; and
fraud determining means for obtaining the history information, and determining whether the present transaction request involves a fraud with reference to the fraud determination rule storing means.

16. A fraud determining system utilizing history information of authorization data, the system comprising:
authorization data receiving means for receiving first authorization data concerning a present transaction request from a user;
authorization data storing means for storing authorization data concerning past transactions by the user;
fraud determination rule storing means for storing a determination rule for determining a fraud from authorization data;
history information creating means for comparing the first authorization data with second authorization data stored in the authorization data storing means and concerning a previous transaction request received from the user immediately before the present transaction request, and creating history information; and
fraud determining means for determining whether the present transaction request involves a fraud, on the basis of the history information and with reference to the fraud determination rule storing means.

17. A fraud determining system according to claim 15, wherein the history information includes at least one of a difference in time of use, or monetary value, between the first authorization data and the second authorization data.

18. A fraud determining system according to claim 16, wherein the history information includes at least one of a difference in time of use, or monetary value, between the first authorization data and the second authorization data.

19. A fraud determining system according to claim 17, wherein the history information includes data regarding the article or service contained in the second authorization data.

20. A fraud determining system according to claim 18, wherein the history information includes data regarding the article or service contained in the second authorization data.

21. A fraud determining system utilizing history information of authorization data, the system comprising:
authorization data receiving means for receiving first authorization data concerning a present transaction request from a user;
authorization data storing means for storing authorization data concerning past transactions by the user;
history information creating means for specifying the first authorization data and authorization data sets obtained from the authorization data storing means and concerning transaction requests received from the user within a predetermined period of time immediately before the present transaction request, and creating history information;
history information adding means for adding the created history information to a record of the first authorization data, and storing the record into the authorization data storing means;
fraud determination rule storing means for storing a determination rule for determining a fraud from authorization data; and
fraud determining means for obtaining the history information, and determining whether the present transaction request involves a fraud with reference to the fraud determination rule storing means.

22. A fraud determining system utilizing history information of authorization data, the system comprising:
authorization data receiving means for receiving first authorization data concerning a present transaction request from a user;
authorization data storing means for storing authorization data concerning past transactions by the user;
fraud determination rule storing means for storing a determination rule for determining a fraud from authorization data;
history information creating means for specifying the first authorization data and authorization data sets obtained from the authorization data storing means and concerning transaction requests received from the user within a predetermined period of time immediately before the present transaction request, and creating history information; and
fraud determining means for determining whether the present transaction request involves a fraud, on the basis of the history information and with reference to the fraud determination rule storing means.

23. A fraud determining system according to claim 21, wherein the history information includes at least one of the number of the authorization data sets and the total of monetary values of the authorization data sets.

24. A fraud determining system according to claim 22, where in the history information includes at least one of the number of the authorization data sets and the total of monetary values of the authorization data sets.

25. A fraud determining system according to claim 21, wherein the history information includes at least one of the article, service, and area information recorded in the authorization data sets.

26. A fraud determining system according to claim 22, wherein the history information includes at least one of the article, service, and area information recorded in the authorization data sets.
